(19) United States
(12) Patent Application Publication
(10) Pub. No.: US 2024/0320537 A1
(43) Pub. Date: Sep. 26, 2024

(54) QUANTUM ERROR CORRECTION USING REAL PROJECTIVE PLANE TOPOLOGY DEFINED STABILIZERS

(71) Applicant: Quantinuum LLC, Broomfield, CO (US)

(72) Inventors: Natalie Christine BROWN, Denver, CO (US); Ciaran RYAN-ANDERSON, Broomfield, CO (US)

(21) Appl. No.: 18/605,140

(22) Filed: Mar. 14, 2024

Related U.S. Application Data
(60) Provisional application No. 63/491,612, filed on Mar. 22, 2023.

(51) Int. Cl. G06N 10/70; G06N 10/20; G06N 10/40

(52) U.S. Cl. CPC G06N 10/70; G06N 10/20; G06N 10/40

(57) ABSTRACT

A quantum computing system comprises a classical computing entity, a controller, and a quantum processor. The controller is configured to control operation of the quantum processor and communicate with the computing entity. The controller causes performance of a syndrome circuit segment to generate a syndrome of a logical qubit. The syndrome circuit segment is performed at least in part by causing performance of a sequence of at-least-two-physical-qubits interactions. The logical qubit comprises a plurality of data qubits logically organized in a real projective plane topology and the sequence of at-least-two-physical-qubits interactions is determined based on stabilizers determined based on the real projective plane topology of the logical qubit. The classical computing entity determines at least one quantum error correction based on the syndrome. A classical memory of the controller or the classical computing entity is updated based on the syndrome and/or the at least one quantum error correction.

### CROSS-REFERENCE TO RELATED APPLICATIONS

This application claims priority to U.S. Application No. 63/491,612, filed Mar. 22, 2023, the content of which is incorporated herein by reference in its entirety.

### TECHNICAL FIELD

Various embodiments relate to quantum error correction using stabilizers defined using a quantum error correction (QEC) code having real projective plane topology.

### BACKGROUND

Complex quantum computations demand levels of precision that are not available in conventional quantum computers due to imperfect control and noise in gate operations between data qubits, for example. Through applied effort, ingenuity, and innovation many deficiencies of prior systems have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products, controllers configured to control operation of quantum processors, and/or the like for performing quantum error correction (QEC) wherein the stabilizers used in performing syndrome circuit segments are defined based on a surface QEC code having a real projective plane topology. For example, in various embodiments, at least one syndrome circuit segment is performed to determine or generate at least one syndrome of a logical qubit. The logical operations performed as part of the syndrome circuit segment are determined based at least in part on stabilizers (also referred to herein as stabilizer operators) that are determined based on a real projective plane topology.

For example, in various embodiments, each logical qubit comprises a plurality of physical data qubits that are logically organized based on a real projective plane topology. The topology of the plurality of data qubits defines and/or determines, at least in part, the stabilizers of the logical qubit. The stabilizers are used to act on the logical qubit (e.g., on the data qubits of the logical qubit in a manner prescribed by the topology of the logical qubit) to extract syndromes from the logical qubit. In various embodiments, the syndromes are used to identify errors that have occurred and/or that errors have occurred, such that corrections for the errors may be determined and/or applied.

According to a first aspect, a method for performing quantum error correction is provided. In an example embodiment, the method is performed by a quantum computing system comprising a classical computing entity, a controller, and a quantum processor. The controller is configured to control operation of the quantum processor and is in communication with the classical computing entity. In an example embodiment, the method comprises causing, by the controller, performance of at least one syndrome circuit segment to generate a syndrome of a logical qubit. The at least one syndrome circuit segment is performed at least in part by causing performance of a sequence of at-least-two-physical-qubits interactions. The logical qubit comprises a plurality of data qubits logically organized in a real projective plane topology. The sequence of at-least-two-physical-qubits interactions is determined based at least in part on one or more stabilizers determined based on the real projective plane topology of the logical qubit. The method further comprises based at least in part on the syndrome of the logical qubit, determining, by the classical computing entity, at least one quantum error correction; and causing, by the controller, a classical memory of at least one of the controller or the classical computing entity to be updated based on at least one of the syndrome or the at least one quantum error correction.

In an example embodiment, each stabilizer of the one or more stabilizers comprises four instances of a same operator, with each instance of the four instances of the same operator acting on a different data qubit of the plurality of data qubits.

In an example embodiment, at least one stabilizer of the one or more stabilizers comprises two instances of a first operator and two instances of a second operator, with each instance of the first operator and each instance of the second operator acting on a different data qubit of the plurality of data qubits.

In an example embodiment, each stabilizer of the one or more stabilizers is a weight four stabilizer.

In an example embodiment, the method further comprises causing, by the controller, the at least one quantum error correction to be applied to the logical qubit.

In an example embodiment, causing the at least one quantum error correction to be applied to the logical qubit comprises at least one of (a) updating a classical qubit registry corresponding to logical qubit based on the at least one quantum error correction, (b) causing performance of a physical correction to one or more data qubits of the logical qubit, or (c) causing a logical operation to be performed at least in part on one or more data qubits of the logical qubit to be modified based at least in part on the at least one quantum error correction.

In an example embodiment, performance of the at least one syndrome circuit segment comprises performance of a plurality of syndrome circuit segments.

In an example embodiment, at least one of at-least-two-physical-qubits interactions of the sequence of at-least-two-physical-qubits interactions includes interaction of at least one ancilla qubit with at least one data qubit of the plurality of data qubits of the logical qubit.

In an example embodiment, the logical qubit is one of a plurality of logical qubits and the at least one ancilla qubit is used to perform syndrome circuit segments for two or more logical qubits of the plurality of logical qubits.

In an example embodiment, updating the classical memory based on at least one of the syndrome or the at least one quantum error correction comprises tracking the syndrome of the logical qubit in the classical memory.

In an example embodiment, coherence of the plurality of data qubits of the logical qubit is maintained during performance of the at least one syndrome circuit segment.

In an example embodiment, the method further comprises, prior to causing performance of the at least one syndrome circuit segment, causing performance of a state preparation circuit segment for preparing a state of a respective ancilla qubit; using the respective ancilla qubit to perform the sequence of at-least-two-physical-qubits interactions, and causing the respective ancilla qubit to be read after the performance of the sequence of at-least-two-physical-qubits interactions, wherein the syndrome of the logical qubit is generated based at least in part on a result of the reading of the respective ancilla qubit.

According to another aspect, a quantum computing system configured for performing quantum error correction is provided. In an example embodiment, the quantum computing system comprises a classical computing entity, a controller, and a quantum processor. The controller is configured to control operation of the quantum processor and is in communication with the classical computing entity. In an example embodiment, the controller is configured to cause performance of at least one syndrome circuit segment to generate a syndrome of a logical qubit. The at least one syndrome circuit segment is performed at least in part by causing performance of a sequence of at-least-two-physical-qubits interactions. The logical qubit comprises a plurality of data qubits logically organized in a real projective plane topology. The sequence of at-least-two-physical-qubits interactions is determined based at least in part on one or more stabilizers determined based on the real projective plane topology of the logical qubit. The controller is further configured to, based at least in part on the syndrome of the logical qubit, determine at least one quantum error correction; and cause a classical memory of at least one of the controller or the classical computing entity to be updated based on at least one of the syndrome or the at least one quantum error correction.

In an example embodiment, each stabilizer of the one or more stabilizers comprises four instances of a same operator, with each instance of the four instances of the same operator acting on a different data qubit of the plurality of data qubits.

In an example embodiment, at least one stabilizer of the one or more stabilizers comprises two instances of a first operator and two instances of a second operator, with each instance of the first operator and each instance of the second operator acting on a different data qubit of the plurality of data qubits.

In an example embodiment, each stabilizer of the one or more stabilizers is a weight four stabilizer.

In an example embodiment, the controller is further configured to cause the at least one quantum error correction to be applied to the logical qubit.

In an example embodiment, causing the at least one quantum error correction to be applied to the logical qubit comprises at least one of (a) updating a classical qubit registry corresponding to logical qubit based on the at least one quantum error correction, (b) causing performance of a physical correction to one or more data qubits of the logical qubit, or (c) causing a logical operation to be performed at least in part on one or more data qubits of the logical qubit to be modified based at least in part on the at least one quantum error correction.

In an example embodiment, performance of the at least one syndrome circuit segment comprises performance of a plurality of syndrome circuit segments.

In an example embodiment, at least one of at-least-two-physical-qubits interactions of the sequence of at-least-two-physical-qubits interactions includes interaction of at least one ancilla qubit with at least one data qubit of the plurality of data qubits of the logical qubit.

In an example embodiment, the logical qubit is one of a plurality of logical qubits and the at least one ancilla qubit is used to perform syndrome circuit segments for two or more logical qubits of the plurality of logical qubits.

In an example embodiment, updating the classical memory based on at least one of the syndrome or the at least one quantum error correction comprises tracking the syndrome of the logical qubit in the classical memory.

In an example embodiment, coherence of the plurality of data qubits of the logical qubit is maintained during performance of the at least one syndrome circuit segment.

In an example embodiment, the controller is configured to, prior to causing performance of the at least one syndrome circuit segment, causing performance of a state preparation circuit segment for preparing a state of a respective ancilla qubit; using the respective ancilla qubit to perform the sequence of at-least-two-physical-qubits interactions, and causing the respective ancilla qubit to be read after the performance of the sequence of at-least-two-physical-qubits interactions, wherein the syndrome of the logical qubit is generated based at least in part on a result of the reading of the respective ancilla qubit.

According to another aspect, a controller configured to control operation of a quantum processor and cause performance of fault tolerant quantum error correction using physical transport of qubits is provided. In an example embodiment, the controller is configured for communicating a classical computing entity. In an example embodiment, the controller is configured (and/or programmed) to cause performance of at least one syndrome circuit segment to generate a syndrome of a logical qubit. The at least one syndrome circuit segment is performed at least in part by causing performance of a sequence of at-least-two-physical-qubits interactions. The logical qubit comprises a plurality of data qubits logically organized in a real projective plane topology. The sequence of at-least-two-physical-qubits interactions is determined based at least in part on one or more stabilizers determined based on the real projective plane topology of the logical qubit. The controller is further configured to, based at least in part on the syndrome of the logical qubit, determine at least one quantum error correction; and cause a classical memory of at least one of the controller or the classical computing entity to be updated based on at least one of the syndrome or the at least one quantum error correction.

In an example embodiment, each stabilizer of the one or more stabilizers comprises four instances of a same operator, with each instance of the four instances of the same operator acting on a different data qubit of the plurality of data qubits.

In an example embodiment, at least one stabilizer of the one or more stabilizers comprises two instances of a first operator and two instances of a second operator, with each instance of the first operator and each instance of the second operator acting on a different data qubit of the plurality of data qubits.

In an example embodiment, each stabilizer of the one or more stabilizers is a weight four stabilizer.

In an example embodiment, the controller is further configured (and/or programmed) to cause the at least one quantum error correction to be applied to the logical qubit.

In an example embodiment, causing the at least one quantum error correction to be applied to the logical qubit comprises at least one of (a) updating a classical qubit registry corresponding to logical qubit based on the at least one quantum error correction, (b) causing performance of a physical correction to one or more data qubits of the logical qubit, or (c) causing a logical operation to be performed at least in part on one or more data qubits of the logical qubit to be modified based at least in part on the at least one quantum error correction.

In an example embodiment, performance of the at least one syndrome circuit segment comprises performance of a plurality of syndrome circuit segments.

In an example embodiment, at least one of at-least-two-physical-qubits interactions of the sequence of at-least-two-physical-qubits interactions includes interaction of at least one ancilla qubit with at least one data qubit of the plurality of data qubits of the logical qubit.

In an example embodiment, the logical qubit is one of a plurality of logical qubits and the at least one ancilla qubit is used to perform syndrome circuit segments for two or more logical qubits of the plurality of logical qubits.

In an example embodiment, updating the classical memory based on at least one of the syndrome or the at least one quantum error correction comprises tracking the syndrome of the logical qubit in the classical memory.

In an example embodiment, coherence of the plurality of data qubits of the logical qubit is maintained during performance of the at least one syndrome circuit segment.

In an example embodiment, the controller is further configured (and/or programmed) to, prior to causing performance of the at least one syndrome circuit segment, causing performance of a state preparation circuit segment for preparing a state of a respective ancilla qubit; using the respective ancilla qubit to perform the sequence of at-least-two-physical-qubits interactions, and causing the respective ancilla qubit to be read after the performance of the sequence of at-least-two-physical-qubits interactions, wherein the syndrome of the logical qubit is generated based at least in part on a result of the reading of the respective ancilla qubit.

According to another aspect, a computer program product comprising at least one non-transitory computer-readable medium is provided. The at least one computer-readable memory stores computer-executable instructions configured to, when executed by a processing element of a controller, cause the controller to control operation of a quantum processor and cause performance of quantum error correction is provided. In an example embodiment, the computer-executable instructions are configured to, when executed by the processing element of the controller, cause the controller to cause performance of at least one syndrome circuit segment to generate a syndrome of a logical qubit. The at least one syndrome circuit segment is performed at least in part by causing performance of a sequence of at-least-two-physical-qubits interactions. The logical qubit comprises a plurality of data qubits logically organized in a real projective plane topology. The sequence of at-least-two-physical-qubits interactions is determined based at least in part on one or more stabilizers determined based on the real projective plane topology of the logical qubit. The controller is further configured to, based at least in part on the syndrome of the logical qubit, determine at least one quantum error correction; and cause a classical memory of at least one of the controller or the classical computing entity to be updated based on at least one of the syndrome or the at least one quantum error correction.

In an example embodiment, each stabilizer of the one or more stabilizers comprises four instances of a same operator, with each instance of the four instances of the same operator acting on a different data qubit of the plurality of data qubits.

In an example embodiment, at least one stabilizer of the one or more stabilizers comprises two instances of a first operator and two instances of a second operator, with each instance of the first operator and each instance of the second operator acting on a different data qubit of the plurality of data qubits.

In an example embodiment, each stabilizer of the one or more stabilizers is a weight four stabilizer.

In an example embodiment, the computer-executable instructions are further configured to, when executed by the processing element of the controller, cause the controller to cause the at least one quantum error correction to be applied to the logical qubit.

In an example embodiment, causing the at least one quantum error correction to be applied to the logical qubit comprises at least one of (a) updating a classical qubit registry corresponding to logical qubit based on the at least one quantum error correction, (b) causing performance of a physical correction to one or more data qubits of the logical qubit, or (c) causing a logical operation to be performed at least in part on one or more data qubits of the logical qubit to be modified based at least in part on the at least one quantum error correction.

In an example embodiment, performance of the at least one syndrome circuit segment comprises performance of a plurality of syndrome circuit segments.

In an example embodiment, at least one of at-least-two-physical-qubits interactions of the sequence of at-least-two-physical-qubits interactions includes interaction of at least one ancilla qubit with at least one data qubit of the plurality of data qubits of the logical qubit.

In an example embodiment, the logical qubit is one of a plurality of logical qubits and the at least one ancilla qubit is used to perform syndrome circuit segments for two or more logical qubits of the plurality of logical qubits.

In an example embodiment, updating the classical memory based on at least one of the syndrome or the at least one quantum error correction comprises tracking the syndrome of the logical qubit in the classical memory.

In an example embodiment, coherence of the plurality of data qubits of the logical qubit is maintained during performance of the at least one syndrome circuit segment.

In an example embodiment, the computer-executable instructions are further configured to, when executed by the processing element of the controller, cause the controller to, prior to causing performance of the at least one syndrome circuit segment, causing performance of a state preparation circuit segment for preparing a state of a respective ancilla qubit; using the respective ancilla qubit to perform the sequence of at-least-two-physical-qubits interactions, and causing the respective ancilla qubit to be read after the performance of the sequence of at-least-two-physical-qubits interactions, wherein the syndrome of the logical qubit is generated based at least in part on a result of the reading of the respective ancilla qubit.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example logical qubit logically organized to provide a QEC code of distance three and having a real projective plane topology that may be used to define stabilizers of an example embodiment.

FIG. 1A is a schematic diagram illustrating the topology of the real projective plane.

FIG. 2 is a schematic diagram illustrating an example logical qubit logically organized to provide a QEC code of distance five and having a real projective plane topology that may be used to define stabilizers of an example embodiment.

FIG. 3 is a schematic diagram illustrating the real projective plane topology of an example logical qubit logically organized to provide a QEC code having a distance p (p a positive integer), according to an example embodiment.

FIG. 4 is a schematic diagram illustrating another logical qubit logically organized to provide an example QEC code of distance three and having a real projective plane topology that may be used to define stabilizers of an example embodiment.

FIG. 5 is a schematic diagram illustrating an example quantum computing system, according to an example embodiment.

FIG. 6 is a flowchart illustrating various processes, operations, and/or procedures performed by a quantum computing system, such as the quantum computing system of FIG. 1, for example, to perform a quantum circuit, according to various embodiments.

FIG. 7 provides a schematic diagram of an example controller configured to control operation of a confinement apparatus, according to an example embodiment.

FIG. 8 is a flowchart illustrating various processes, operations, and/or procedures performed by a controller, such as the controller of FIG. 7, for example, to determine a syndrome of a logical qubit, according to various embodiments.

FIG. 9 provides a schematic diagram of an example computing entity that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide methods, systems, apparatuses, computer program products, controllers configured to control operation of quantum processors, and/or the like for performing quantum error correction (QEC) wherein the stabilizers used in performing syndrome circuit segments are defined based on a surface QEC code having a real projective plane topology. For example, in various embodiments, at least one syndrome circuit segment is performed to determine or generate at least one syndrome of a logical qubit. The logical operations performed as part of the syndrome circuit segment are determined based at least in part on stabilizers (also referred to herein as stabilizer operators) that are determined based on a real projective plane topology of the logical qubit.

In various embodiments, a quantum processor comprises a plurality of data qubits that are logically partitioned, clustered, and/or organized into a plurality of logical qubits. Each of the plurality of logical qubits is formed of a respective plurality of data qubits that are logically organized based on a real projective plane topology. The term “logically organized” is used herein to indicate that the operational relationships between the plurality of data qubits of a logical qubit are determined based on and/or configured to conform to the real projective plane topology. In at least one embodiment, the data qubits of the plurality of data qubits that form the logical qubit may be moved and/or transported independently of one another. Thus, the term “logically organized” is used herein to clarify that the plurality of data qubits that form the logical qubit need not be physically organized based on the real projective plane topology. In particular, the interactions between the data qubits of the logical qubit used to determine the stabilizers are governed, organized, and/or determined based on the real projective plane topology. In various embodiments, the mobility of the data qubits enables the arbitrary physical re-organizing of the data qubits such that the stabilizers may be determined (e.g., the appropriate qubit interactions can be performed).

For example, in various embodiments, each logical qubit comprises a plurality of physical data qubits that are logically organized based on a real projective plane topology. The topology of the plurality of data qubits defines and/or determines, at least in part, the stabilizers of the logical qubit. The stabilizers are used to act on the logical qubit (e.g., on the data qubits of the logical qubit in a manner prescribed by the topology of the logical qubit) to extract syndromes from the logical qubit. In various embodiments, the syndromes are used to identify which errors have occurred and/or that errors have occurred, such that corrections for the errors may be determined and/or applied and/or such that the effects of the errors may be mitigated and/or reduced.

In various embodiments, performance of a quantum program, algorithm, or circuit (referred to as a quantum circuit herein) comprises the performance of one or more quantum error correction cycles. For example, quantum error correction cycles may be performed at various points before, during, and/or after the performance of the quantum circuit.

During a quantum error correction cycle, one or more syndrome circuit segments are performed so as to generate, determine, and/or extract syndromes from one or more logical qubits used in performance of the quantum circuit. In various embodiments, a logical qubit comprises a plurality of data qubits. The plurality of data qubits is logically organized based on a real projective plane topology to form a binary logical element of the quantum processor (analogous to a bit of a classical, semiconductor-based processor). In various embodiments, a quantum error correction cycle may further include the determination of one or more quantum error corrections based on the generated, determined, and/or extracted syndromes and applying the one or more quantum error corrections to a respective logical qubit.

In various embodiments, at least one syndrome circuit segment is performed to generate a syndrome of a respective logical qubit. The at least one syndrome circuit segment is performed at least in part by causing performance of a sequence of at-least-two-physical-qubits interactions (e.g., two-qubit gates and/or the like). The sequence of at-least-two-physical-qubits interactions is determined based on stabilizers of the logical qubit. Based at least in part on the syndrome of the logical qubit, at least one quantum error correction is determined and applied to the logical qubit.

In various embodiments, the quantum error correction(s) comprise software corrections that are applied by tracking quantum errors experienced by a logical qubit in a classical qubit registry corresponding to the logical qubit (e.g., stored in a classical, semiconductor-based memory of a controller configured to control operation of the quantum processor), physically applying a correction to one or more data qubits of the logical qubit, and/or modifying a logical operation performed on one or more data qubits of the logical qubit based at least in part on the determined quantum error correction.

In various embodiments, the logical qubit is logically organized using a real projective plane topology such that the logical relationships between the data qubits of the logical qubit are determined based on the real projective plane topology of the logical qubit. For example, the logical relationships between the data qubits of the logical qubit determines how gates are performed on the logical qubit, the stabilizers of the logical qubit, and how the value (e.g., |0> or |1>) of the logical qubit is read and/or determined. For example, the logical relationships between the data qubits of the logical qubit determines which operations are performed on which data qubits of the logical qubit to cause a particular logical gate or operation to be performed on the logical qubit.

The real projective plane is a non-orientable, two-dimensional manifold. Thus, the real projective plane is a one-sided surface. The real projective plane is the closed topological manifold that is obtained by projecting the points of a plane from a fixed point not on the plane, with the addition of the line at infinity. The real projective plane can be described topologically, in terms of a construction based on the Möbius strip: if one could glue the (single) edge of the Möbius strip to itself in the correct direction, one would obtain the projective plane (this cannot be done in three-dimensional space without the surface intersecting itself). Equivalently, gluing a disk along the boundary of the Möbius strip gives the projective plane. Topologically, it has Euler characteristic 1, hence a demigenus (non-orientable genus, Euler genus) of 1.

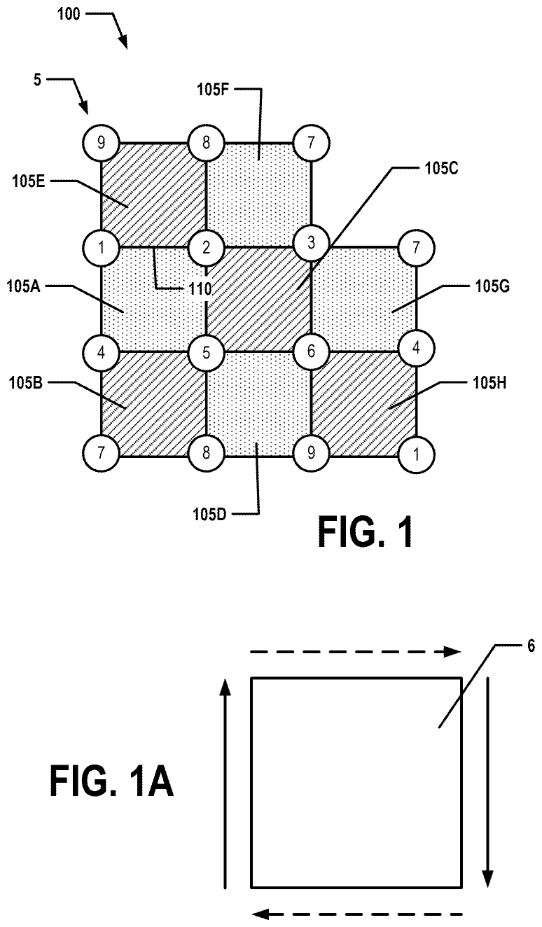

For example, FIG. 1A provides an illustration of the topology of the real projective plane, where the opposite edges of the square 6 are glued to one another with a half-twist such that the portions of the edge of the square 6 corresponding to the heads of the dashed arrows are glued to one another, the portions of the edge of the square corresponding to the tails of the dashed arrows are glued to one another, the portions of the edge of the square corresponding to the heads of the solid line arrows are glued to one another, and the portions of the edge of the square corresponding to the tails of the solid line arrows are glued to one another.

Logically organizing the data qubits of the logical qubit based on a real projective plane topology reduces the number of error combinations that can occur that are not detectable, identifiable, and/or correctable, compared to conventional QEC techniques.

Complex quantum computations demand levels of precision that are not available in conventional quantum computers due to imperfect control and noise in gate operations between data qubits, for example. Proposed schemes for quantum error correction include the extraction of syndromes which generally includes the interaction of ancilla qubits with data qubits of a logical qubit. However, if not performed carefully, such interactions between ancilla qubits and data qubits can cause faults to spread ruinously, leading to logical errors that would have otherwise been correctable given their initial weight. Thus, technical problems exist regarding how to perform quantum computations with levels of precision that are sufficient for performing complex computations. Moreover, technical problems exist regarding how to extract information from the logical qubits needed to diagnose and correct errors without causing additional spreading of errors.

Various embodiments provide technical solutions to such technical problems. For example, various embodiments provide for the performance of quantum error correction using sequences of at-least-two-qubits interactions that are determined based on stabilizers defined based on a real projective plane topology. In particular, the topology of the stabilizers used to determine and/or extract the syndrome and/or the topology of the logical qubit determines the errors or combinations of errors to which the syndromes are sensitive. By organizing the data qubits of the logical qubit using a real projective plane topology, the number of error combinations that can occur that are not detectable, identifiable, and/or correctable, are reduced compared to conventional QEC techniques. Thus, more errors can be detected and corrected, leading to increased computational fidelity and a reduction in the number of circuits that need to be re-executed due to spreading of errors. Thus, various embodiments provide improvements over conventional quantum error correction schemes.

### Example Logical Qubit and Stabilizer Topology

FIG. 1 illustrates an example logical qubit 100 of distance three. The logical qubit comprises a plurality of data qubits 5 that are logically organized based on a real projective plane topology. For the logical qubit 100, the plurality of data qubits 5 includes 9 data qubits. In FIG. 1, each data qubit of the plurality of data qubits 5 is represented by a labelled circle, where circles having the same label refer to the same data qubit. For example, each of the circles labelled 9 refer to the same ninth data qubit. Thus, one can see that by connecting the boundaries of the illustrated logical qubit 100 such that each of the circles with the same label overlap (e.g., are one point), the topology of the logical qubit is that of a real projective plane.

As can be seen by comparing FIGS. 1 and 1A, the topology of the logical qubit 100 is that of the real projective plane where opposite edges are “glued” to one another with a half twist.

FIG. 1 also illustrates the stabilizers 105 (e.g., 105A-105H) of the logical qubit 100, where the hatched squares indicate weight four Z stabilizers and the dotted squares indicate weight four X stabilizers. The stabilizers 105A-105H form a set of stabilizers of the logical qubit 100. For example, stabilizer 105A is the operator \hat{Z}₁\hat{Z}₂\hat{Z}₄\hat{Z}₅, where \hat{Z}ᵢ is the Pauli Z operator acting on the ith qubit. Similarly, stabilizer 105B is the operator \hat{X}₄\hat{X}₅\hat{X}₇\hat{X}₈, where \hat{X}ᵢ, is the Pauli X operator acting on the ith qubit. Stabilizers 105C-105H each respectively comprise four Pauli Z operators or Pauli X operators, respectively that act on respective data qubits as indicated by the labelled circles on the vertices/corners of the respective squares illustrating the stabilizers 105. In an example embodiment, the hatched squares indicate weight four X stabilizers (e.g., stabilizer operators comprising four Pauli X operators) and the dotted squares indicate weight four Z stabilizers (e.g., stabilizer operators comprising four Pauli Z operators). In an example embodiment, the set of stabilizers may include Y stabilizers (e.g., stabilizers including Pauli Y operators) instead of one of the X stabilizers or Z stabilizers.

The stabilizers 105A-105H form a set of stabilizers of the logical qubit 100. In various embodiments, each stabilizer 105A-105H of the set of stabilizers of the logical qubit 100 is a weight four stabilizer. The weight of a stabilizer indicates the number of operators of the stabilizer. For example, a weight four stabilizer includes four operators (e.g., four Pauli Z operators, four Pauli X operators, a combination of Pauli X and Pauli Z operators that includes a total of four operators, and/or the like).

In an example embodiment, the logical qubit 100 is, in part, similar to a logical qubit of a toroidal topology surface code. However, the boundaries of the logical qubit 100 redefined with respect to a toroidal topology surface code. This redefinition of the boundaries makes the stabilizers more sensitive to various errors and/or error combinations. In general, a stabilizer S is an operator configured to act on a logical qubit wave function |ψ [symbol] such that |ψ [symbol] =|ψ [symbol] . Therefore, we have [symbol] |S|ψ [symbol] =1. When an error or combination of errors E occurs that does not commute or that anti-commutes with the stabilizer S (ES=−SE), the wavefunction of the logical qubit is evolved to wavefunction E|ψ [symbol] , and the action of the stabilizer is [symbol] ψ|ESE|ψ [symbol] =−1. Thus, evaluating the stabilizers 105 enables the identification and/or determination of when an error has occurred for errors E that do not commute and/or that anti-commute with at least one stabilizer of the logical qubit. Through the use of a quantum error decoder, the particular error, particular combination of errors, and/or the effect of the error(s) can be identified such that the error can be corrected and/or the effects thereof may be mitigated and/or minimized.

The logical qubit 100 is a Calderbank-Shor-Steane (CSS) qubit. In general, a CSS qubit is defined such that each stabilizer only includes one type of Pauli operator (e.g., stabilizer 105A includes only instances of the Pauli Z operator, stabilizer 105B includes only instances of Pauli Z operator, etc.).

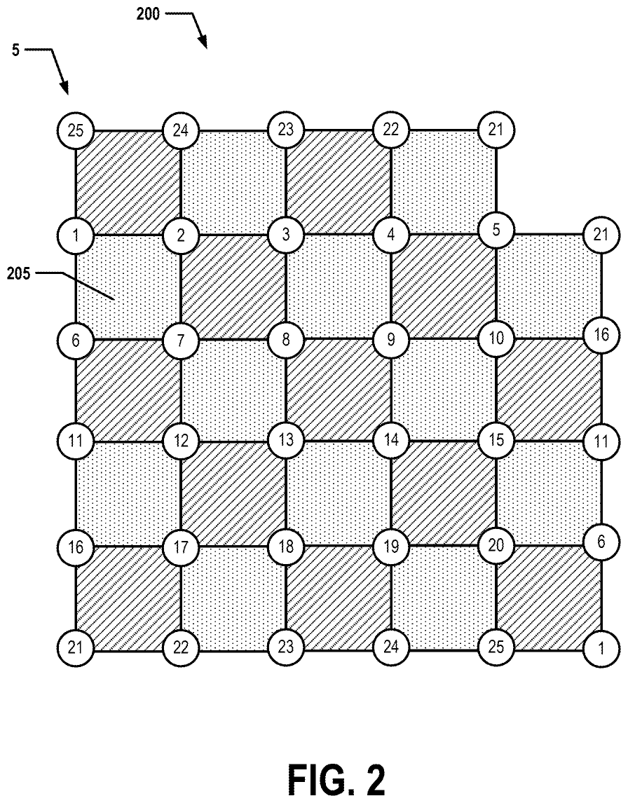

FIG. 2 illustrates another logical qubit 200 that is a distance five logical qubit. The plurality of data qubits of the logical qubit 200 are logically organized based on a real projective plane topology. The plurality of qubits 5 used to form the logical qubit 200 includes twenty-five data qubits. The logical qubit 200 is a CSS qubit. The logical qubit 200 defines a set of stabilizers 205 that are used, in various embodiments, to define sequences of at-least-two-qubits interactions that are used to extract syndromes from the logical qubit 200.

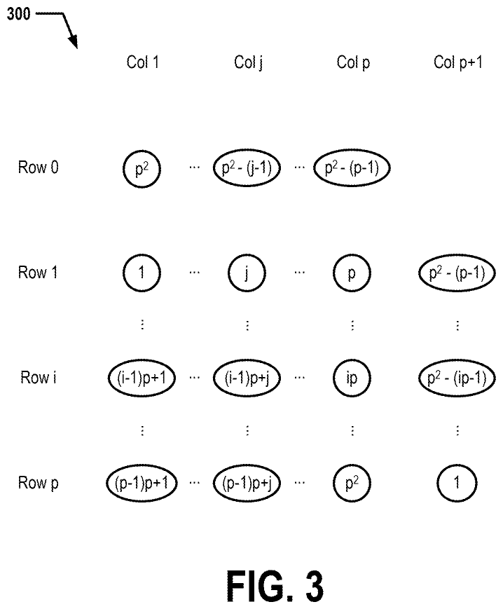

FIG. 3 illustrates a logical qubit 300 of a generalized distance p, where p is a positive integer, where the plurality of logical qubits is logically organized based on a real projective plane topology. The data qubit of the j^{th} column (1≤j≤p) of the zeroth row of the logical qubit 300 is data qubit number p²−(j−1). The data qubit of the i^{th} row (1≤i≤p) and j^{th} column (1≤j≤p) of the logical qubit 300 is data qubit number (i−1)p+j. The data qubit of the i^{th} row and the (p+1)th column of the logical qubit 300 is data qubit number p²−(ip-1).

Notably, the distance p can be even or odd. Rotated toric codes only enable the use of even distances. Thus, various embodiments provide the technical advantage of additional flexibility in the size of the logical qubit and the ability to tailor the size of the logical qubit based on the hardware of the quantum processor (size, transport speed, topology, and/or the like).

The stabilizers of the logical qubit 300, while not shown, are determined similarly as described above with respect to logical qubit 100. For example, squares are formed between data qubits of row i and column j, row i+1 and column j, row i and column j+1 and row i+1 and column j+1, for each pair of indices i, j with 1≤j≤p and 0≤i≤p−1 (other than i=0 and j=p). Each of the stabilizers are then assigned a stabilizer type (e.g., X stabilizers or Z stabilizers) such that squares that share an edge 110 are of different types. For example, referring to FIG. 1, the square representing stabilizer 105E shares edge 110 with the square representing stabilizer 105A and stabilizer 105A is a different type from stabilizer 105E. For example, the hatching and dotted square pattern of the logical qubit 100, 200 forms a checkerboard pattern.

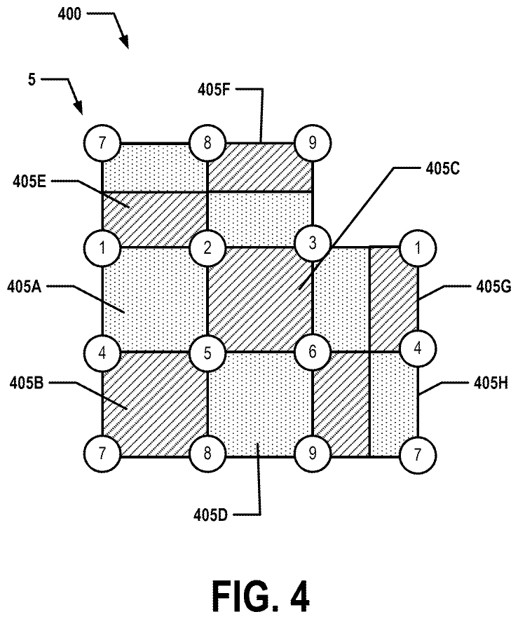

FIG. 4 illustrates another example logical qubit 400 comprising a plurality of data qubits 5 that are logically organized based on a real projective plane topology. The logical qubit 400 is a distance three logical qubit that includes nine data qubits. The logical qubit 400 is a non-CSS qubit. For example, stabilizers 405A, 405B, 405C, and 405D are the same as stabilizers 105A, 105B, 105C, and 105D. However, the stabilizers along the boundary of the logical qubit 400 (e.g., 405E, 405F, 405G, and 405H) differ from the stabilizers along the boundary of the logical qubit 100 (e.g., 105E, 105F, 105G, 105H). In particular, the boundary stabilizers 405E, 405F, 405G, and 405H are defined to be combined X and Z stabilizers. For example, boundary stabilizer 405E is \hat{Z}₉\hat{Z}₈\hat{X}₁\hat{X}₂, in an example embodiment.

In the non-CSS logical qubit 400, the combined or mixed boundary stabilizers 405E, 405F, 405G, and 405H enact the twisting of the topology of the logical qubit 400 rather the boundary itself enacting the twisting of the topology. For example, the boundary of the logical qubit 400 corresponds to a torus topology. However, the mixing of the of the stabilizers along the boundary results on a logical qubit 400 that comprises data qubits 5 that are logically organized based on a real projective plane topology.

As should be understood, while the non-CSS logical qubit 400 is illustrated with distance p=3, non-CSS logical qubits with distance p greater than 3 are used in various embodiments.

Logical qubits 100, 200, 300, and 400 illustrate examples of logical qubits formed by organizing the respective plurality of data qubits 5 of a logical qubit based on a real projective plane topology and defining and/or determining the stabilizers of the logical qubit based on the topology of the logical qubit. Various other logical qubits are logically organized based on a real projective plane topology in various other embodiments and the respective set of stabilizers for the respective logical qubits are defined based thereon. For example, various logical qubits may include various numbers of data qubits, be of different distances, and/or the like.

### Example Quantum Computing System

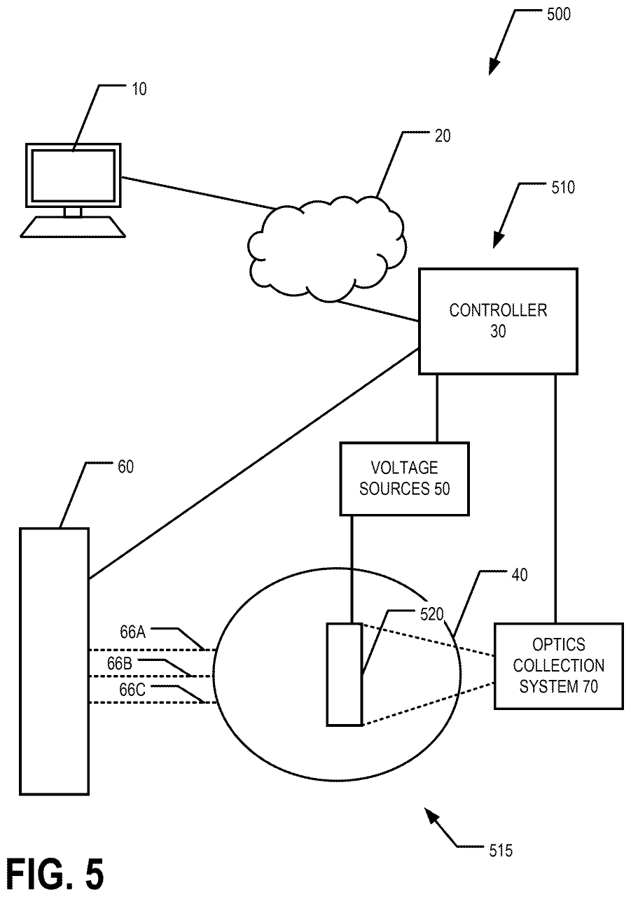

QEC techniques may be used with various types of quantum processors, such as quantum charge-coupled device (QCCD)-based quantum processors, Josephson junction-based quantum processors, superconducting-based quantum processors, photonic-based quantum processors, quantum object spin-based quantum processors, semiconductor quantum dot-based quantum processors, and/or the like. FIG. 5 illustrates one example of a quantum computing system 500 configured to perform quantum error correction. As should be understood, various embodiments relate to a variety of types of quantum computing systems. In various embodiments, a quantum processor comprises a plurality of physical qubits. The physical qubits include data qubits that are logically organized into logical qubits and ancilla qubits that are used to mediate and/or perform the at-least-two-qubits interactions used during syndrome extraction.

In some embodiments, the physical locations of at least some of the physical qubits of the quantum processor are fixed. In some embodiments, the physical locations of the data qubits of the quantum processor are not fixed (e.g., the physical qubit register is reconfigurable). For example, various embodiments relate to quantum computing systems that use ions, neutral atoms, quantum dots, quantum particles, and/or the like as qubits.

For example, FIG. 5 illustrates an example quantum computing system 500 comprising a classical computing entity 10 and a quantum computer 510. The quantum computer comprises a controller 30 and a quantum processor 515. In the illustrated embodiment, the quantum processor 515 is quantum charge-coupled device (QCCD)-based quantum processor. However, various embodiments may of the quantum computing system 500 may include various types of quantum processors. The controller 30 and the classical computing entity 10 are in communication with one another via a direct wired and/or wireless connection and/or via one or more wired and/or wireless networks 20.

In the illustrated embodiment, the (QCCD-based) quantum processor 515 comprises a confinement apparatus 520 that is used to confine manipulatable objects such that various functions may be performed on the manipulatable objects. For example, in various embodiments, the confinement apparatus 520 is an ion trap and/or the like. For example, in various embodiments, the manipulatable objects are ions, multipole and/or charged molecules, charged particles, quantum objects, and/or the like. In various embodiments, the manipulatable objects are used as the physical qubits (e.g., data qubits and ancilla qubits) of the quantum processor 515. Various functions may be performed on the manipulatable objects such as state preparation, performance of logical gates, state reading/determination, cooling, transport between different locations of the confinement apparatus 520, and/or the like. In various embodiments, the logical gates performed on the manipulatable objects include transversal gates. Transversal gates are those for which an error-correcting code can achieve the transformation on a logical qubit by applying that gate on each of the data qubits of the logical qubit. For example, in a 5-qubit code, if you can achieve logical Hadamard on a logical qubit by applying Hadamard on each of the five data qubits of the logical qubit, that Hadamard gate is a transversal gate. In various embodiments, logical gates that are not transversal gates are used. For example, logical gates may be performed using lattice surgery and/or other logical gating techniques.

In various embodiments, the manipulatable objects comprise ancilla qubits and a plurality of data qubits that are logically partitioned and/or organized into one or more logical qubits. In various embodiments, the ancilla qubits are used to probe the data qubits and/or logical qubits to determine one or more syndromes thereof. For example, the ancilla qubits are used to probe the data qubits and/or logical qubits such that the coherence of the respective data qubits of the respective logical qubits is maintained during performance of syndrome circuit segments. This enables the generation, determination, and/or tracking of syndromes of a logical qubit without destroying the coherence of the respective data qubits of the logical qubit.

In various embodiments, the quantum system controller 30 is configured, programmed, and/or the like to control the quantum processor 515. For example, the quantum processor 515 comprises a confinement apparatus 520 configured to confine a plurality of manipulatable objects. The quantum system controller 30 is configured to control operation of the confinement apparatus 520. In an example embodiment, the quantum processor 515 comprises a plurality of qubits (e.g., physical data qubits organized into logical qubits, ancilla qubits, and/or the like). In various embodiments, the data qubits and ancilla qubits are each embodied by a respective manipulatable object of the plurality of manipulatable objects confined by the confinement apparatus 520. In various embodiments, the quantum computer 510 includes or communicates with databases and/or programs (not shown), such as a quantum error decoder and/or quantum error correction determination application, program, and/or the like (e.g., stored by and/or operating on the classical computing entity 10). For example, the databases may be stored by one or more classical computing entities 10 that are in communication with the controller 30 via one or more wired and/or wireless networks 20 and/or stored by memory local to the controller 30.

In various embodiments, the quantum processor 515 comprises means for controlling the evolution of quantum states of the qubits. For example, in the illustrated example embodiment, the quantum processor 515 comprises a cryostat and/or vacuum chamber 40 enclosing a confinement apparatus 520 (e.g., an ion trap and/or the like), one or more manipulation sources 60, one or more voltage sources 50, and/or one or more optics collection systems 70. For example, the cryostat and/or vacuum chamber 40 may be a temperature and/or pressure-controlled chamber. In an example embodiment, the one or more manipulation sources 60 may comprise one or more lasers (e.g., optical lasers, microwave sources, and/or the like). In various embodiments, the one or more manipulation sources 60 are configured to manipulate and/or cause a controlled quantum state evolution of one or more manipulatable objects within the confinement apparatus 520. In various embodiments, the manipulatable objects within the confinement apparatus 520 (e.g., ions trapped within an ion trap) act as the data qubits and/or ancilla qubits of the quantum processor 515 of the quantum computer 510. For example, in an example embodiment, wherein the one or more manipulation sources 60 comprise one or more lasers, the lasers may provide one or more laser beams to manipulatable objects confined by the confinement apparatus 520 within the cryostat and/or vacuum chamber 40. For example, the manipulation sources 60 may generate and/or provide laser beams configured to ionize manipulatable objects, initialize manipulatable objects within the defined two-state qubit space of the quantum processor, perform gates (e.g., logical gates on logical qubits and/or physical gates on physical qubits) one or more qubits of the quantum processor, read a quantum state of one or more qubits of the quantum processor, and/or the like.

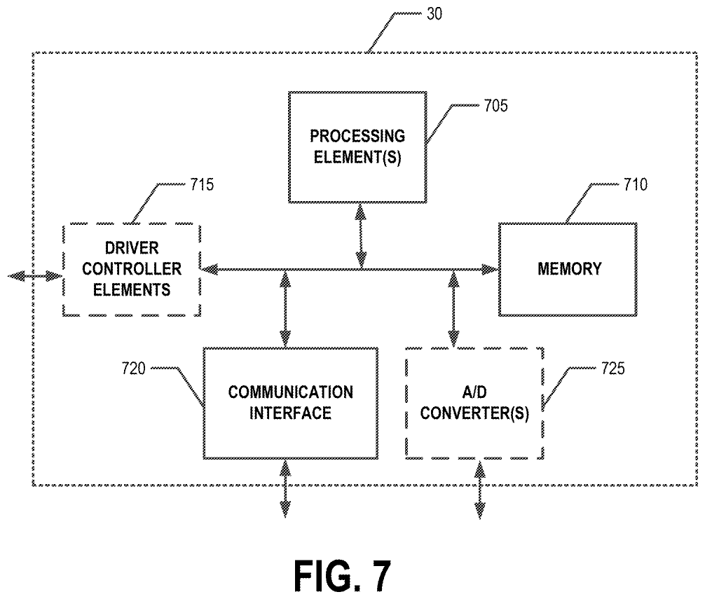

In various embodiments, the quantum processor 515 and/or the quantum computer 510 comprises an optics collection system 70 configured to collect and/or detect photons generated by qubits (e.g., during reading procedures). The optics collection system 70 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the data and/or ancilla qubits of the quantum computer 510. In various embodiments, the detectors may be in electronic communication with the quantum system controller 30 via one or more A/D converters 725 (see FIG. 7) and/or the like.

In various embodiments, the quantum processor 515 and/or quantum computer 510 comprises one or more voltage sources 50. For example, the voltage sources 50 may comprise a plurality of voltage drivers and/or voltage sources and/or at least one RF driver and/or voltage source. For example, in various embodiments, the voltage sources 50 include a plurality of arbitrary waveform generators (AWGs). The voltage sources 50 may be electrically coupled to the corresponding potential generating elements (e.g., electrodes) of the confinement apparatus 520, in an example embodiment.

In various embodiments, a classical computing entity 10 is configured to allow a user to provide input to the quantum computer 510 (e.g., via a user interface of the computing entity 10) and receive, view, and/or the like output from the quantum computer 510. In various embodiments, the classical computing entity 10 is configured to perform one or more classical computations in real-time or near real-time with performance of the quantum circuit by the quantum computer 510. For example, during the performance of the quantum circuit, the controller 30 may provide one or more syndromes of one or more logical qubits and the classical computing entity 10 determines and provides one or more corresponding quantum error corrections such that the controller 30 can perform the quantum error correction in real-time while the quantum circuit is being performed.

The classical computing entity 10 is referred to as “classical” herein as the classical computing entity 10 uses semiconductor-based hardware to perform classical computing operations. The classical computing entity 10 may be in communication with the quantum system controller 30 of the quantum computer 510 via one or more wired or wireless networks 20 and/or via direct wired and/or wireless communications. In an example embodiment, the classical computing entity 10 may translate, configure, format, and/or the like information/data, quantum computing algorithms and/or circuits, and/or the like into a computing language, executable instructions, command sets, and/or the like that the quantum system controller 30 can understand and/or implement. For example, the controller 30 is configured to generate machine code level commands configured to, when executed by the appropriate components of the quantum computer 510, cause the performance of a quantum circuit by the quantum computer 510. In various embodiments the classical computing entity 10 may provide quantum computing algorithms and/or circuits in a computing language that the quantum system controller 30 resolves into operations and/or individual or sets of machine code level commands.

In various embodiments, the classical computing entity 10 and the controller 30 are communicatively coupled in a low delay manner. For example, the controller 30 may be configured to call classical operations, programs, modules, functions, and/or the like operating on the classical computing entity 10 (e.g., using a foreign function interface (FFI), application program interface (API), or other appropriate interface). The results of these exchanges between the controller 30 and the classical computing entity 10 may be used to dynamically change and/or affect the quantum circuit performed by the quantum processor 515 in real-time, mid-circuit, and/or the like. Therefore, latency in communication between the classical computing entity 10 and the controller 30 is minimized, in an example embodiment.

In various embodiments, the quantum system controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, and/or the like) within the cryostat and/or vacuum chamber 40 and/or configured to manipulate and/or cause a controlled evolution of quantum states of one or more manipulatable objects within the confinement apparatus 520. For example, the quantum system controller 30 may cause a controlled evolution of quantum states of one or more manipulatable objects within the confinement apparatus 520 to execute a quantum circuit and/or algorithm. For example, the quantum system controller 30 may cause a reading procedure comprising coherent shelving to be performed, possibly as part of executing a quantum circuit and/or algorithm. Additionally, the quantum system controller 30 is configured to communicate and/or receive input data from the optics collection system 70 and corresponding to the reading of the quantum state of physical data qubits and/or ancilla qubits of the quantum computer 510. In various embodiments, the manipulatable objects confined within the confinement apparatus 520 are used as data and/or ancilla qubits of the quantum computer 510. In various embodiments, the data qubits are organized into logical qubits and the ancilla qubits are used to non-invasively probe the data qubits and/or logical qubits.

In various embodiments, performance of a quantum circuit comprises the performance of one or more quantum error correction cycles. During a quantum error correction cycle, one or more syndrome circuit segments are performed so as to generate and/or extract syndromes from one or more logical qubits used in performance of the quantum circuit. A syndrome circuit segment is performed at least in part by causing performance of a sequence of at-least-two-physical-qubits interactions where the sequence of at-least-two-physical-qubits interactions are determined based at least in part on the set of stabilizers of the logical qubit. The at-least-two-physical-qubits interactions between the respective ancilla qubit and one or more data qubits of a logical qubit causes information regarding the one or more data qubits of the logical qubit to be encoded by the ancilla qubit in a non-invasive manner (e.g., without destroying the coherence of the one or more data qubits). Thus, the state of the ancilla qubit can be used to determine and/or extract a syndrome of the logical qubit.

### Example Operation of a Quantum Computing System

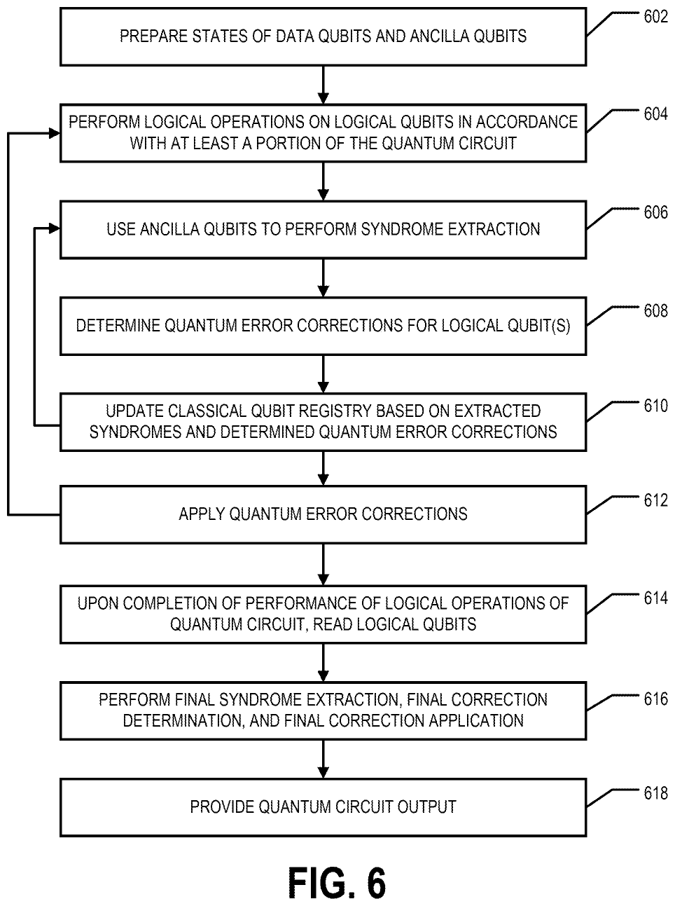

FIG. 6 is a flowchart illustrating various processes, operations, and/or procedures performed by a quantum computing system, such as the quantum computing system 500, for example, to perform a quantum circuit, according to various embodiments. For example, a quantum circuit may be obtained by the controller 30 (e.g., accessed from memory 710, received via communication interface 720, and/or the like (See FIG. 7)), compiled, and/or the like. The controller 30 may then cause the quantum computing system 500 (possibly due to user input received via the classical computing entity 10 and/or via a user interface of the controller 30) to begin executing the quantum circuit.

Starting at step/operation 602, the states of the physical qubits are prepared. As used herein term physical qubits refers to qubits that are embodied by a respective manipulatable object. Respective physical qubits are data qubits or ancilla qubits. For example, the data qubits and the ancilla qubits are examples of the physical qubits. The one or more logical qubits each comprise a respective plurality of data qubits logically organized in a real projective plane topology and each form a respective binary logical element of the quantum processor.

In various embodiments, the controller 30 controls operation of the voltage sources 50 to generate and provide voltage signals that causes physical qubits to be transported into and out of respective interaction zones defined by the quantum processor 515 (e.g., locations of the confinement apparatus 520 that are configured to have respective manipulation signals intersect therewith such that physical qubits located in the interaction zones are affected by the respective manipulation signals). The controller 30 further controls operation of one or more manipulation signals 60 such that respective manipulation signals are provided to respective interaction zones defined by the quantum processor 515 to prepare the respective quantum states of the respective physical qubits. For example, in various embodiments, the state preparation comprises causing the quantum state of one or more physical qubits to be a known state of a defined two-state qubit space of the energy structure of the respective manipulatable objects.

In an example embodiment, the state preparation operation is not fault tolerant. However, as no quantum information has yet been encoded into the data qubits at this point in performing the quantum circuit (e.g., the performance of logical gates on the physical and/or logical qubits for which state preparation is being performed has not yet begun), the state preparation operation can be performed as a repeat-until-success circuit segment, ensuring in real-time that the state of the respective qubit is fault tolerantly prepared. For example, execution of a syndrome circuit segment may be used to determine whether the state preparation operation was performed successfully.

At step/operation 604, one or more logical operations are performed on logical qubits in accordance with at least a portion of the quantum circuit. For example, the controller 30 may cause the quantum processor 515 to perform one or more logical operations on logical qubits of the quantum processor 515 in accordance with the quantum circuit. For example, in an example embodiment, performing the one or more logical operations on the logical qubit(s) comprises transporting one or more data qubits of the logical qubit(s) into and/or out of respective interaction zones, causing interactions between respective data qubits of the logical qubit(s), performing single and/or at-least-two-physical-qubits gates (e.g., gates that cause interaction of two or more physical qubits) on respective data qubits of the logical qubit(s), and/or the like, in accordance with the quantum circuit. In various embodiments, the physical qubits (data qubits and ancilla qubits) of the quantum computer system 500 may be physically transportable within the confinement apparatus 520 such that any selected pair of physical qubits may be transported into a same interaction zone and interacted with on another (e.g., have a two-qubit gate performed thereon). For example, the quantum circuit indicates which gates are to be performed on which logical qubits and in which order.

In I various embodiments, the performed gates are transversal gates. For example, a single qubit gate is performed on a logical qubit by performing corresponding single qubit gates on each of the plurality of data qubits of the logical qubit in series, parallel, and/or a combination thereof. In various embodiments, a two-qubit gate is performed on a first logical qubit and a second logical qubit by causing corresponding two qubit gates to be performed on respective pairs of first data qubits of the first logical qubit and second data qubits of the second logical qubit.

In various embodiments, at least one non-transversal gate is used. For example, in an example embodiment, the logical gates of the quantum circuit (e.g., single logical gates and/or at least two logical qubits gates) and/or one or more gates of a syndrome circuit segment are non-transversal gates. For example, at least one gate may be used (e.g., in the quantum circuit and/or in a syndrome circuit segment) where a first set of operators is applied to a first subset of data qubits of a logical qubit and a second (different) set of operators is applied to a second subset of data qubits of the logical qubit to perform the gate. For example, in an example embodiment, sets of physical gates that result in the performance of respective logical operations on one or more logical qubits are used to perform logical operations.

At various points during performance of the quantum circuit, syndromes of one or more logical qubits are generated, determined, and/or extracted. In particular, at step/operation 606, ancilla qubits are used to perform syndrome extraction. For example, one or more ancilla qubits are used to non-invasively probe the data qubits and/or logical qubits. For example, the interactions between a respective ancilla qubit and one or more data qubits of a logical qubit causes information regarding the one or more data qubits of the logical qubit to be encoded by the ancilla qubit in a non-invasive manner (e.g., without destroying the coherence of the one or more data qubits). The at-least-two-physical-qubits interactions used to generate, determine, and/or extract the syndromes of the logical qubit are determined based on the stabilizers of the logical qubit. In other words, the sequence(s) of at-least-two-physical-qubits interactions used to generate, determine, and/or extract the syndromes of the logical qubit are defined at least in part on the real projective plane topology of the logical qubit.

In various embodiments, the syndrome extractions are performed through the performance of syndrome circuit segments. Performance of a syndrome circuit segment comprises performance of a sequence at-least-two-physical-qubits interactions. Respective at-least-two-physical-qubits interactions are performed on respective data qubits and the ancilla qubits based on the stabilizers of the logical qubit such that information regarding the data qubit is encoded to the quantum state of the ancilla qubit without disturbing the quantum state of the data qubit. In various embodiments, performance of a syndrome circuit segment may include performing various aspects of lattice surgery and/or interactions between two or more ancilla qubits.

In various embodiments, a syndrome circuit segment is performed using one or more ancilla qubits and one or more data qubits of a logical qubit to generate, determine, and/or extract a syndrome of the logical qubit. A syndrome circuit is a relatively short circuit (compared to the quantum circuit) configured to encode information regarding one or more data qubits of the logical qubit to the quantum state of one or more ancilla qubits such that the ancilla qubits may be read to determine a syndrome of the logical qubit comprising the one or more data qubits without destroying the coherence and/or quantum information stored in the one or more data qubits of the logical qubit. For example, a syndrome of a logical qubit is configured to provide information regarding the occurrence, location, and/or type of errors experienced by a logical qubit.

For example, performance of a syndrome circuit includes performance of each stabilizer of the logical qubit (e.g., stabilizers 105A-105H of the logical qubit 100 or stabilizers 405A-405H of logical qubit 400). For example, performance of a first syndrome circuit segment to generate, determine, and/or extract a syndrome from logical qubit 100 includes performing and/or evaluating the stabilizer operator 105A 21222425, which includes interactions between one or more ancilla qubits and the first, second, fourth, and fifth data qubits of the logical qubit 100 based on a Pauli Z operator. For example, the one or more ancilla qubits and the first, second, fourth, and fifth data qubits may be transported to enable the sequence of at-least-two-physical-qubits interactions (e.g., two qubit gates) indicated by the stabilizer operator 105A to be performed. For example, the data qubits and/or confinement apparatus may be configured to enable transportation operations such that arbitrary pairings of data qubits and/or ancilla qubits may be performed.

In various embodiments, one or more quantum error correction cycles may be performed to generate, determine, and/or extract syndromes of one or more logical qubits in a fault tolerant manner. As used herein, fault tolerance refers to design principles that guarantee faults do not spread too quickly through a quantum circuit to become uncorrectable logical errors. For example, each quantum error correction cycle includes the performance of one or more syndrome circuit segments. In various embodiments, generating, determining, and/or extracting the syndromes of one or more logical qubits in a fault tolerate manner comprises performing multiple syndrome extraction cycles for a respective logical qubit and comparing the results of the multiple syndrome extraction cycles. For example, the fault tolerance of the quantum error correction may be a probability-based fault tolerance.

Continuing with FIG. 6, at step/operation 608, one or more respective quantum error corrections for one or more logical qubits are determined based on the respective syndromes generated, determined, and/or extracted therefrom. For example, the one or more syndromes generated, determined, and/or extracted from a logical qubit during the syndrome extraction step (e.g., step/operation 606) are provided to a quantum error decoder operating on the classical computing entity 10 and/or controller 30. The quantum error decoder is a program, application, and/or the like configured to determine one or more quantum error corrections for a logical qubit based on one or more syndromes for a logical qubit. In an example embodiment, a quantum error decoder is embodied as one or more look up tables. In various embodiments, the quantum error decoder is configured to determine one or more quantum error corrections based on one or more syndromes in real time or near real time with respect to receiving the one or more syndromes as input.

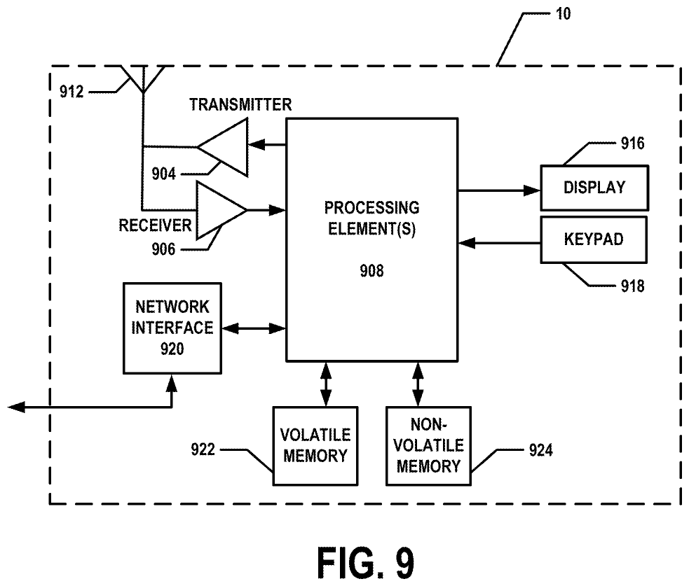

In various embodiments, in various scenarios, the quantum error correction determined is an identity operation. For example, when no errors are detected and/or the one or more syndromes for the logical qubit do not indicate the presence of an error, the determined quantum error correction is to not make any adjustments or changes to the qubit. For example, the determined quantum error correction may be to apply a software correction that is equivalent to applying an identity operator to the classical qubit registry corresponding to the logical qubit. At step/operation 610, a classical qubit registry (e.g., stored in memory 710 and/or memory 922, 924 (see FIG. 9)) is updated based on the extracted syndromes and/or the determined quantum error corrections. For example, the controller 30 may cause the extracted syndromes and/or determined quantum error corrections to be tracked (e.g., in classical memory). In an example embodiment, the values of the syndromes (and flags, if relevant) and/or the determined quantum error corrections are stored for the entirety of the performance of the quantum circuit. In an example embodiment, the values of the syndromes and/or the determined quantum error corrections are tracked for windows of time (e.g., of a set temporal or number of logical gates length, until a triggering event is identified and correspond error corrections are applied, and/or the like).

At step/operation 612, the one or more quantum error corrections for the logical qubit are applied to the logical qubit. For example, the controller 30 controls operation of various components (e.g., voltage sources 50, manipulation sources 60, and/or the like) of the quantum processor 515 to cause the one or more quantum error corrections to be applied to the logical qubit. In various embodiments, the quantum error correction(s) comprise software corrections that are applied by tracking quantum errors experienced by a logical qubit in a classical qubit registry corresponding to the logical qubit (e.g., stored in a memory of the controller 30 and/or a memory of the classical computing entity 10), physically applying a correction to one or more data qubits of the logical qubit (e.g., through one or more single and/or two qubit gates applied to various data qubits of the logical qubit), and/or modifying a logical operation performed on one or more data qubits of the logical qubit based at least in part on the determined quantum error correction.

In various embodiments, a quantum error correction is not applied immediately upon determination of the quantum error correction. For example, in various embodiments, syndromes and quantum error corrections are tracked (e.g., in memory 710 and/or memory 922, 924) for a period of time and/or until a triggering event is identified. For example, the syndromes and/or quantum error corrections are tracked in a classical qubit registry, in an example embodiment.

In an example embodiment, the triggering event corresponds to the determination that a logical gate that does not commute with one or more of the quantum error corrections (e.g., a non-Clifford gate, in an example embodiment) is to be performed on a logical qubit. For example, it may be determined that the controller has scheduled and/or the quantum circuit dictates the upcoming performance of a logical gate that does not commute with one or more of the quantum error corrections (e.g., a non-Clifford gate, in an example embodiment) on the logical qubit. Upon identification of the triggering event, any required physical corrections may be scheduled (ahead of the performance of the gate that does not commute with the one or more quantum error corrections) and/or the performance of the gate that does not commute with the one or more quantum error corrections may be scheduled in modified manner such that the performance of the gate is modified to account for and/or include one or more quantum error corrections.

As should be understood, some quantum error corrections are updates of the classical representation of the Pauli frame of the qubit and are applied to the logical qubit through an update to the classical qubit registry (e.g., a software quantum error correction).

In various embodiments, the process of performing one or more logical operations on one or more logical qubits, performing syndrome generation/determination/extraction, determining quantum error corrections, and applying the quantum error corrections are repeated a plurality of times until the logical operations of the quantum circuit are completed. For example, completing a quantum circuit may include state preparation of physical qubits, performance of logical operations, performance of quantum error correction cycles, performance of logical operations, performance of quantum error correction cycles, performance of logical operations, performance of quantum error correction cycles, . . . , and, once all of the logical operations of the quantum circuit have been performed, reading of the logical qubits. As should be understood, in various embodiments, state preparation of the ancilla qubits is performed between each quantum error correction cycle and/or between performance of quantum error correction cycles for different logical qubits, in an example embodiment.

Thus, once it is determined that all of the logical operations of the quantum circuit have been performed, the process continues to step/operation 614. At step/operation 614, one or more of the logical qubits are read, in accordance with the quantum circuit. For example, the data qubits of a logical qubit may be transported (in serial and/or in parallel) into respective reading zones (which may or may not be the same physical portions of the confinement apparatus 520 as the interaction zones). The respective data qubits may be rotated into desired reading frames, in accordance with the quantum circuit and read.

For example, a reading operation may include a manipulation signal being incident upon a physical qubit (e.g., a data qubit). Depending on which state of the two-state qubit space that the physical qubit is in, the physical qubit will either fluoresce in response to the manipulation signal being incident thereon, or will not fluoresce. Based on the fluorescence observed (or not observed) by the optics collection system 70, the quantum state of the physical qubit is determined. Based on the quantum states of the data qubits of a logical qubit, the state of the logical qubit is determined. The state of the logical qubit is then used to determine a result of the quantum circuit.

At step/operation 616, in various embodiments a final syndrome extraction, final correction determination, and final correction application is performed. For example, the final syndrome(s) of a logical qubit is determined based on the result of reading the data qubits of the logical qubit. For example, the distribution of quantum states of the data qubits of the logical qubit provides an indication of errors experienced by the logical qubit. The final syndrome(s) of the logical qubit are then used (e.g., by the quantum error decoder) to determine a final correction. In various embodiments, the final correction is a software quantum error correction. For example, as the data qubits have been read, the quantum information stored by the data qubits has been destroyed. Thus, no physical correction can be applied. For example, the final correction is a software correction such as a Pauli frame rotation, in an example embodiment, the Final correction is applied by updating a classical qubit registry corresponding to the logical qubit based on the final correction.

At step/operation 618, after the respective final corrections have been applied to each of the logical qubits, the output of the quantum circuit is provided. For example, the controller 30 may provide the output of the quantum circuit to the classical computing entity 10. In another example, the classical computing entity 10 may provide an indication of the output of the quantum circuit via a user interface thereof (e.g., display 916) and/or transmit an indication of the output of the quantum circuit to another computing entity (e.g., via transmitter 904 and/or network interface 920).

### Example Controller of a Quantum Computing System

In various embodiments, a quantum computer 510 comprises a quantum system controller 30 and a quantum controller 515. The quantum system controller 30 is configured to control various components of a quantum processor 515. For example, the controller 30 is configured to control the operation of components of the quantum processor 515 to cause the performance of a quantum circuit including a plurality of quantum error correction cycles. For example, various embodiments are configured to perform one or more quantum error corrections for one or more data qubits in real-time and/or near real-time with respect to the occurrence of one or more quantum errors experienced by the one or more data qubits, which may be evaluated as a conditional block.

In various embodiments, the quantum system controller 30 is in communication with an optics collection system 70 such that the quantum system controller 30 is configured to receive input data captured and/or generated by the optics collection system 70. The quantum system controller 30 is further configured to perform quantum error correction via a software-based correction and/or via the physical application of a quantum error correction to one or more qubits (e.g., by controlling of one or more voltage sources 50 and/or manipulation sources 60). In various embodiments, the quantum system controller 30 is further configured to control a cryostat system and/or vacuum system controlling the temperature and pressure within the cryostat and/or vacuum chamber 40, cooling system, and/or other systems controlling the environmental conditions (e.g., temperature, humidity, pressure, and/or the like) within the cryostat and/or vacuum chamber 40.

As shown in FIG. 7, in various embodiments, the quantum system controller 30 may comprise various quantum system controller elements including processing element(s) 705, memory 710, driver controller elements 715, a communication interface 720, analog-digital (A/D) converter elements 725, and/or the like. In various embodiments, the quantum system controller 30 is configured to receive input data generated by the optics collection system via the A/D converter(s) 725. In various embodiments, the processing element(s) 705 are configured to operate as described herein. In various embodiments, the quantum system controller 30 may include additional quantum system controller elements configured to perform various functions described herein. In an example embodiment, the controller 30 is similar to the controller described in U.S. Application No. 63/235,022, filed Aug. 19, 2021, the content of which is incorporated herein by reference in its entirety.

In various embodiments, the processing element(s) 705 comprises one or more processing devices such as processors, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing elements and/or circuitry, and/or the like. The term circuitry may refer to an entirely hardware embodiment or a combination of hardware and computer program products. In an example embodiment, a processing element 705 of the quantum system controller 30 comprises a clock and/or is in communication with a clock.

In various embodiments, the memory 710 comprises non-transitory memory such as volatile and/or non-volatile memory storage such as one or more of hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store a queue of commands to be executed to cause a quantum algorithm and/or circuit to be executed (e.g., an executable queue), (classical) qubit records corresponding the qubits of quantum computer (e.g., in a qubit record data store, qubit record database, qubit record table, and/or the like), a calibration table, computer program code (e.g., in a one or more computer languages, specialized quantum system controller language(s), and/or the like), and/or the like. In an example embodiment, execution of at least a portion of the computer program code stored in the memory 710 (e.g., by a processing element 705) causes the quantum system controller 30 to perform one or more steps, operations, processes, procedures and/or the like for generating one or more sets of commands configured to cause the quantum processor 515 to perform at least a portion of a quantum circuit; to update one or more qubit registries; and/or the like. In an example embodiment, execution of at least a portion of the computer program code stored in the memory 710 causes the quantum system controller 30 to cause one or more commands to be performed.

In various embodiments, the driver quantum system controller elements 715 include one or more drivers and/or quantum system controller elements each configured to control one or more drivers. In various embodiments, the driver quantum system controller elements 715 may comprise drivers and/or driver controllers. For example, the driver controllers may be configured to cause one or more corresponding drivers to be operated in accordance with executable instructions, commands, and/or the like generated, scheduled, and executed by the quantum system controller 30. For example, the processing element 705 may generate one or more commands to be performed by a first driver.

In various embodiments, the driver controller elements 715 enable the quantum system controller 30 to operate a voltage sources 50, manipulation sources 60, cooling system, vacuum systems, and/or the like. In various embodiments, the drivers may be laser drivers (e.g., configured to operate and/or control one or more manipulation sources 60); vacuum component drivers; drivers for controlling the flow of current and/or voltage applied to electrodes (e.g., configured to operate and/or control one or more voltage sources 50) used for maintaining and/or controlling the trapping potential of the confinement apparatus 520 (and/or other drivers for providing driver action sequences to potential generating elements of the confinement apparatus); cryostat and/or vacuum system component drivers; cooling system drivers, and/or the like.

Each driver controller element 715 corresponds to an endpoint within the system (e.g., a component of a manipulation source 60, a component of a voltage source 50 (radio frequency voltage sources, arbitrary waveform generators (AWG), direct digital synthesizer (DDS), and/or other waveform generator), a component of a cooling and/or vacuum system, a component of the optics collection system 70, and/or the like). Each endpoint within the quantum computer 510 represents an individual hardware control. Each endpoint has its own set of accepted micro-commands, in various embodiments. Examples include but are not limited to a voltage source 50 such as a direct digital synthesizer (DDS), component of an optics collection system 70 such as a photomultiplier tube (PMT), a component of a manipulation source 60 such as a laser driver and/or optical modulator switch, and/or general-purpose output (GPO). Individual commands for a DDS allow for setting power level, frequency and phase of a controlling signal generated thereby. Commands for a PMT interface include start/stop photon count and reset of count, in various embodiments. Commands for a GPO endpoint include setting and/or clearing one or more output lines. These output lines can be used to control external hardware in a manner synchronized with the quantum circuit execution.

In various embodiments, the quantum system controller 30 comprises means for communicating and/or receiving signals from one or more optical receiver components (e.g., of the optics collection system 70). For example, the quantum system controller 30 may comprise one or more analog-digital (A/D) converter elements 725 configured to receive signals from one or more optical receiver components (e.g., a photodetector of the optics collection system 70), calibration sensors, and/or the like. In various embodiments, the A/D converter elements 725 are configured to write the input data generated by converting the received signals generated by one or more optical receiver components of the optics collection system 70 to memory 710.

In various embodiments, the quantum system controller 30 may comprise a communication interface 720 for interfacing and/or communicating with, for example, a classical computing entity 10. For example, the quantum system controller 30 may comprise a communication interface 720 for receiving executable instructions, command sets, and/or the like from the computing entity 10 and providing output received from the quantum computer 510 (e.g., from an optics collection system 70) and/or the result of a processing the output to the computing entity 10. In various embodiments, the computing entity 10 and the quantum system controller 30 may communicate via a direct wired and/or wireless connection and/or via one or more wired and/or wireless networks 20.

### Example Operation of a Controller of Quantum Computing System

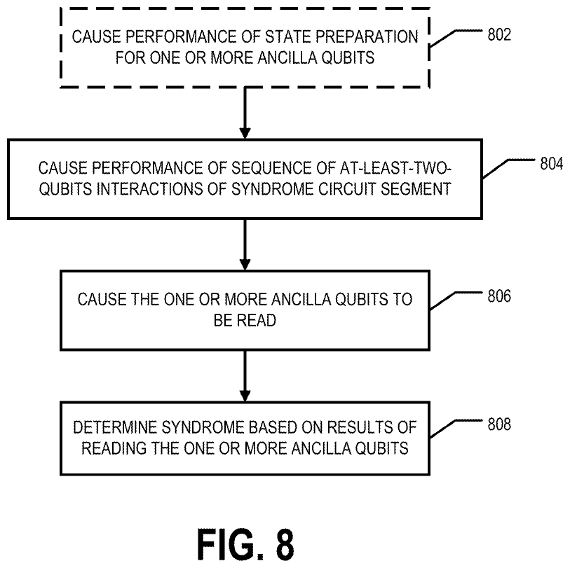

FIG. 8 is a flowchart illustrating various processes, operations, and/or procedures performed by a controller 30, for example, to determine a syndrome of a logical qubit, according to various embodiments. For example, the processes, operations, and/or procedures of FIG. 8 may be performed as part of step/operation 606, in an example embodiment.

Starting at step/operation 802, the controller 30 causes the performance of a state preparation operation on one or more ancilla qubits. For example, the performance of a state preparation operation on an ancilla qubit causes the quantum state of the ancilla qubit to be a known state (e.g., a particular state of the two-state qubit space). For example, the controller 30 may control operation of one or more voltage sources 50, manipulation sources 60, and/or the like to cause the one or more ancilla qubits to be located in appropriate locations of the confinement apparatus 520 such that the one or more manipulation signals are incident on respective ones of the one or more ancilla qubits such that the respective quantum states of the one or more ancilla qubits are caused to be in a known state.

In various embodiments, one or more ancilla qubits may be used to generate, determine, and/or extract syndromes from a plurality of logical qubits. For example, an ancilla qubit is used to perform syndrome circuit segments for two or more logical qubits of the plurality of logical qubits, in an example embodiment. In such embodiments, previous syndrome values are stored in a classical qubit registry (stored in memory 710 or memory 922, 924) and the ancilla qubits may be re-initialized through the performance of state preparation operations and used again. This reduces the overall number of physical qubits required to perform a quantum circuit because each logical qubit need not have dedicated ancilla qubits. In various embodiments, this technical improvement is enabled at least in apart by an all-to-all connectivity of the physical qubits.

At step/operation 804, the controller 30 causes the performance of a sequence of at-least-two-physical-qubits interactions in accordance with the syndrome circuit segment. In various embodiments, the specific sequence of at-least-two-physical-qubits interactions is controlled, determined, and/or defined by the stabilizers of the logical qubit. As described elsewhere herein in detail, the stabilizers of the logical qubit are defined and/or determined based at least in part on the topology with which the plurality of data qubits of the logical qubit are logically organized. For example, in various embodiments, the sequence of at-least-two-physical-qubits interactions are the physical performance of one or more stabilizer operators. For example, the sequence of at-least-two-physical-qubits interactions causes interactions between one or more ancilla qubits and particular data qubits of the logical qubit that cause the evaluation of one or more stabilizer operators. Therefore, the sequence of at-least-two-physical-qubits interactions are determined based at least in part on the topology (e.g., the real projective plane topology) of the logical qubit. In various embodiments, an at-least-two-physical-qubits interaction may be a two or more ancilla qubit interaction, a two or more data qubit interaction, an at least one ancilla qubit and at least one data qubit interaction, and/or the like, in accordance with the quantum circuit and/or syndrome circuit segment.

The at-least-two-physical-qubits interactions of the sequence of at-least-two-physical-qubits interactions causes the non-invasive (e.g., such that the quantum information stored by the data qubit is not destroyed) transference of information regarding the quantum state of one or more data qubits to one or more ancilla qubits.

At step/operation 806, the one or more ancilla qubits are read. For example, ancilla qubits may be isolated from the data qubits of the logical qubits. For example, in an example embodiment, the data qubits may be transported out of the interaction zones containing the ancilla qubits and/or the ancilla qubits may be moved to reading zones defined by the quantum processor 515. The controller 30 then controls operation of one or more manipulation sources 60 to cause one or more appropriate manipulation signals to be incident on each of the ancilla qubits. The controller 30 then controls operation of the optics collection system 70 to observe any fluorescence emitted by the ancilla qubits such that the respective quantum states of the ancilla qubits can be determined.

At step/operation 808, the syndrome(s) of the respective logical qubit are determined based on the quantum states determined for the ancilla qubits through the reading operation. For example, the controller 30 determines a quantum state of each ancilla qubit based on a signal received from an element of the optics collection system 70 corresponding to the location of the respective ancilla qubit. For example, when a photodetector configured to watch the location of a first ancilla qubit observes significant fluorescence during a reading operation of the first ancilla qubit, it is determined that the first ancilla qubit is in a first state of the two-state qubit space. When a photodetector configured to watch the location of a second ancilla qubit does not observe significant fluorescence during a reading operation of the second ancilla qubit, it is determined that the second ancilla qubit is in a second state of the two-state qubit space. In an example embodiment, a syndrome of the respective logical qubit is a function of the quantum state of one or more of the ancilla qubits. Thus, the controller 30 determines the syndrome(s) for the respective logical qubit based on the respective determined quantum states of the ancilla qubits.

In an example embodiment, a syndrome circuit segment is performed more than once to determine the syndromes generated, determined, and/or extracted through the multiple instances of the syndrome circuit segment are the same or not and/or to determine a representative syndrome based on the multiple instances of performing the syndrome circuit segment. For example, in an example embodiment, steps/operations 802-806 are performed a plurality of times and step/operation 808 includes processing and/or analyzing the distribution of syndromes generated, determined, and/or extracted through the plurality of instances of performing steps/operations 802-806 to determine a representative syndrome(s) for the respective logical qubit. For example, a first syndrome circuit segment may be performed a plurality of times and a distribution of generated, determined, and/or extracted syndromes may be analyzed and/or processed to determine a representative syndrome(s) corresponding to the first syndrome circuit that are to be used in determining a quantum error correction for the respective logical qubit, used to update the classical qubit registry for the respective logical qubit, and/or the like. For example, by repeating the first syndrome circuit segment multiple times, uncertainties in measurements, at-least-two-physical-qubits interactions, reading operations, and/or the like may be “averaged” out.

In an example embodiment, when one or more syndromes are generated, determined, and/or extracted from a respective logical qubit through the performance of the syndrome circuit segment differs from the corresponding one or more syndromes stored in the classical qubit registry corresponding to the respective logical qubit (e.g., stored in memory 710 and/or memory 922, 924), the classical qubit registry is updated to reflect and/or include the most recently determined (representative) syndrome(s).

In various embodiments, a number of syndrome circuit segments are performed, and a plurality of syndromes are generated, determined, and/or extracted for a respective logical qubit. For example, different syndrome circuit segments are configured to identify and/or characterize different quantum errors that may be experienced by the respective logical qubit. In an example embodiment each syndrome circuit segment corresponds to one stabilizer of the logical qubit, a subset of stabilizers of the set of stabilizers of the logical qubit, or each stabilizer of the set of stabilizers of the logical qubit. In various embodiments, the controller 30 is programed to be able to perform each of a defined set of syndrome circuit segments. In an example embodiment, during each quantum error correction cycle, each of the syndrome circuit segments of the defined set of syndrome circuit segments are performed. In an example embodiment, a first plurality of syndrome circuit segments is performed and, based on the results thereof, the controller 30 determines whether additional (and possibly which) syndrome circuit segments of the defined set of syndrome circuit segments need to be performed.

For example, for a logical qubit logically organized in a real projective plane topology (e.g., such as logical qubits 100, 200, 300, 400) having distance p, the logical qubit includes p² data qubits and p²−1 stabilizers are defined. A string of bits consisting of the results of measuring the p²−1 stabilizers is the syndrome, in an example embodiment. In various embodiments, the syndrome may be determined a plurality of times (e.g., two to p times, in an example embodiment) to generate a plurality of strings of bits consisting of the results of the respective occurrence of stabilizer measurements. The plurality of strings of bits of stabilizer measurements (also referred to as a stabilizer volume) are generated (e.g., through the controller 30 controlling operation of various components of the quantum processor 510) and provided to the classical computing entity 10, in an example embodiment.

### Example Computing Entity

FIG. 9 provides an illustrative schematic representative of an example classical computing entity 10 (also referred to as computing entity herein) that can be used in conjunction with embodiments of the present disclosure. In various embodiments, a classical computing entity 10 is a classical (e.g., semiconductor-based) computer configured to allow a user to provide input to the quantum computer 510 (e.g., via a user interface of the computing entity 10) and receive, display, analyze, and/or the like output from the quantum computer 510. In an example embodiment, the classical computing entity 10 is part of the controller 30.

As shown in FIG. 9, a classical computing entity 10 can include an antenna 912, a transmitter 904 (e.g., radio), a receiver 906 (e.g., radio), and a processing element 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a quantum system controller 30, other computing entities 10, and/or the like. The computing entity 10 can include a network interface 920, which may provide signals to and receive signals in accordance with an interface standard of applicable network systems to communicate with various entities, such as a quantum system controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 916 and/or speaker/speaker driver coupled to a processing element 908 and a touch screen, keyboard, mouse, and/or microphone coupled to a processing element 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FORAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

In various embodiments, the classical computing entity 10 is configured to receive information from the controller 30 (e.g., ancilla qubit values, data qubit and/or logical qubit values, syndromes corresponding to respective logical qubits, and/or the like) and perform various processes based thereon. For example, the classical computing entity 10 may receive ancilla qubit values and determine one or more syndromes for one or more logical qubits. For example, the classical computing entity 10 may operate a quantum error decoder and/or otherwise be configured to determine one or more quantum error corrections for one or more logical qubits based on one or more respective syndromes for the one or more logical qubits. For example, the classical computing entity 10 may determine one or more quantum error corrections for respective logical qubits and provide (e.g., transmit) the quantum error corrections such that the controller 30 receives and can cause performance of the quantum error corrections. In an example embodiment, the classical computing entity 10 stores and/or updates one or more qubit registries (e.g., in memory 922, 924) based on one or more quantum error corrections.

### Technical Advantages

Complex quantum computations demand levels of precision that are not available in conventional quantum computers due to imperfect control and noise in gate operations between data qubits, for example. Proposed schemes for quantum error correction include the extraction of syndromes which generally includes the interaction of ancilla qubits with data qubits of a logical qubit. However, if not performed carefully, such interactions between ancilla qubits and data qubits can cause faults to spread ruinously, leading to logical errors that would have otherwise been correctable given their initial weight. Thus, technical problems exist regarding how to perform quantum computations with levels of precision that are sufficient for performing complex computations. Moreover, technical problems exist regarding how to extract information from the logical qubits needed to diagnose and correct errors without causing additional spreading of errors.

Various embodiments provide technical solutions to such technical problems. For example, various embodiments provide for the performance of quantum error correction using sequences of at-least-two-qubits interactions that are determined based on stabilizers defined based on a real projective plane topology. In particular, the topology of the stabilizers used to determine and/or extract the syndrome and/or the topology of the logical qubit determines the errors or combinations of errors to which the syndromes are sensitive. By organizing the data qubits of the logical qubit using a real projective plane topology, the number of error combinations that can occur that are not detectable, identifiable, and/or correctable, are reduced compared to conventional QEC techniques. Thus, more errors can be detected and corrected, leading to increased computational fidelity and a reduction in the number of circuits that need to be re-executed due to spreading of errors. Thus, various embodiments provide improvements over conventional quantum error correction schemes.

For example, for a logical qubit logically organized in accordance with a conventional rotated planar distance code having distance three and comprising nine data qubits, 24 unique logical errors are undetectable using the corresponding stabilizers. For logical qubit 100, 18 unique logical errors are undetectable using the corresponding stabilizers. For logical qubit 400, only 12 unique logical errors are undetectable using the corresponding stabilizers. Thus, various embodiments provide technical improvements over conventional quantum error correction by reducing the number of unique logical errors that are undetectable by the syndrome extraction of an example embodiment compared to conventional syndrome extraction.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method performed by a quantum computing system comprising a classical computing entity, a controller, and a quantum processor, the controller configured to (a) control operation of the quantum processor and (b) communicate with the classical computing entity, the method comprising:
causing, by the controller, performance of at least one syndrome circuit segment to generate a syndrome of a logical qubit, the at least one syndrome circuit segment performed at least in part by causing performance of a sequence of at-least-two-physical-qubits interactions, wherein the logical qubit comprises a plurality of data qubits logically organized in a real projective plane topology and the sequence of at-least-two-physical-qubits interactions is determined based at least in part on one or more stabilizers determined based on the real projective plane topology of the logical qubit;
based at least in part on the syndrome of the logical qubit, determining, by the classical computing entity, at least one quantum error correction; and
causing, by the controller or the classical computing entity, a classical memory of at least one of the controller or the classical computing entity to be updated based on at least one of the syndrome or the at least one quantum error correction.

2. The method of claim 1, wherein each stabilizer of the one or more stabilizers comprises four instances of a same operator, with each instance of the four instances of the same operator acting on a different data qubit of the plurality of data qubits.

3. The method of claim 1, wherein at least one stabilizer of the one or more stabilizers comprises two instances of a first operator and two instances of a second operator, with each instance of the first operator and each instance of the second operator acting on a different data qubit of the plurality of data qubits.

4. The method of claim 1, wherein each stabilizer of the one or more stabilizers is a weight four stabilizer.

5. The method of claim 1, further comprising causing, by the controller, the at least one quantum error correction to be applied to the logical qubit.

6. The method of claim 5, wherein causing the at least one quantum error correction to be applied to the logical qubit comprises at least one of (a) updating a classical qubit registry corresponding to logical qubit based on the at least one quantum error correction, (b) causing performance of a physical correction to one or more data qubits of the logical qubit, or (c) causing a logical operation to be performed at least in part on one or more data qubits of the logical qubit to be modified based at least in part on the at least one quantum error correction.

7. The method of claim 1, performance of the at least one syndrome circuit segment comprises performance of a plurality of syndrome circuit segments.

8. The method of claim 1, at least one of at-least-two-physical-qubits interactions of the sequence of at-least-two-physical-qubits interactions includes interaction of at least one ancilla qubit with at least one data qubit of the plurality of data qubits of the logical qubit.

9. The method of claim 8, wherein the logical qubit is one of a plurality of logical qubits and the at least one ancilla qubit is used to perform syndrome circuit segments for two or more logical qubits of the plurality of logical qubits.

10. The method of claim 1, wherein updating the classical memory based on at least one of the syndrome or the at least one quantum error correction comprises tracking the syndrome of the logical qubit in the classical memory.

11. The method of claim 1, wherein coherence of the plurality of data qubits of the logical qubit is maintained during performance of the at least one syndrome circuit segment.

12. The method of claim 1, further comprising, prior to causing performance of the at least one syndrome circuit segment, causing performance of a state preparation circuit segment for preparing a state of a respective ancilla qubit; using the respective ancilla qubit to perform the sequence of at-least-two-physical-qubits interactions, and causing the respective ancilla qubit to be read after the performance of the sequence of at-least-two-physical-qubits interactions, wherein the syndrome of the logical qubit is generated based at least in part on a result of the reading of the respective ancilla qubit.

13. A controller of a quantum computing system, the controller (a) configured to control operation of the quantum processor and (b) comprising a processing element and a memory storing executable instructions configured to, when executed by the processing element, cause the controller to at least:
cause performance of at least one syndrome circuit segment to generate a syndrome of a logical qubit, the at least one syndrome circuit segment performed at least in part by causing performance of a sequence of at-least-two-physical-qubits interactions, wherein the logical qubit comprises a plurality of data qubits logically organized in a real projective plane topology and the sequence of at-least-two-physical-qubits interactions is determined based at least in part on one or more stabilizers determined based on the real projective plane topology of the logical qubit;
based at least in part on the syndrome of the logical qubit, determine at least one quantum error correction; and
cause a classical memory of at least one of the controller or the classical computing entity to be updated based on at least one of the syndrome or the at least one quantum error correction.

14. The controller of claim 13, wherein each stabilizer of the one or more stabilizers comprises four instances of a same operator, with each instance of the four instances of the same operator acting on a different data qubit of the plurality of data qubits.

15. The controller of claim 13, wherein at least one stabilizer of the one or more stabilizers comprises two instances of a first operator and two instances of a second operator, with each instance of the first operator and each instance of the second operator acting on a different data qubit of the plurality of data qubits.

16. The controller of claim 13, wherein each stabilizer of the one or more stabilizers is a weight four stabilizer.

17. The controller of claim 13, wherein the executable instructions are further configured to, when executed by the processing element, cause the controller to at least cause the at least one quantum error correction to be applied to the logical qubit.

18. The controller of claim 17, wherein causing the at least one quantum error correction to be applied to the logical qubit comprises at least one of (a) updating a classical qubit registry corresponding to logical qubit based on the at least one quantum error correction, (b) causing performance of a physical correction to one or more data qubits of the logical qubit, or (c) causing a logical operation to be performed at least in part on one or more data qubits of the logical qubit to be modified based at least in part on the at least one quantum error correction.

19. The controller of claim 13, wherein updating the classical memory based on at least one of the syndrome or the at least one quantum error correction comprises tracking the syndrome of the logical qubit in the classical memory.

20. The controller of claim 13, wherein coherence of the plurality of data qubits of the logical qubit is maintained during performance of the at least one syndrome circuit segment.
